(19) United States
(12) Patent Application Publication
(10) Pub. No.: US 2006/0178866 A1
(43) Pub. Date: Aug. 10, 2006

(54) Directory-oriented electronic document batch translation processing method and system

(75) Inventors: Chaucer Chiu, Taipei (TW); Jenny Xu, Shanghai (CN)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/053,570

(22) Filed: Feb. 7, 2005

(51) Int. Cl. G06F 17/28

(52) U.S. Cl. 704/2

(57) ABSTRACT

A directory-oriented electronic document batch translation processing method and system is proposed, which is designed for use in conjunction with a computer platform for the purpose of providing a directory-oriented batch translation processing function for translating a batch of user-desired document files from a first specified language to a second specified language, and which is characterized by the capability of performing a batch translation processing procedure on all document files or one or more user-selected document file under a user-selected directory from the file management system so as to translate the text contents of these document files from a first specified language to a second specified language. This feature allows batch translation to be more convenient and efficient for the user to operate than prior art.

### BACKGROUND OF THE INVENTION

1. Field of the Invention

This invention relates to information technology (IT), and more particularly, to a directory-oriented electronic document batch translation processing method and system which is designed for use in conjunction with a computer platform, such as a desktop computer, a notebook computer, a tablet computer, a pocket computer, or the like, for providing a directory-oriented batch translation processing function that allows the computer platform to translate the text contents of a batch of electronic documents under a selected directory in the file management system of the computer platform into another language, such as from Traditional Chinese to Simplified Chinese, from English to Traditional Chinese, from Japanese to Traditional Chinese, and so on.

2. Description of Related Art

In this age of globalization, it is very common for computer user to handle electronic documents whose text contents are written in various natural languages, such as English, Traditional Chinese, Simplified Chinese, Japanese, German, French, to name just a few. If a user knows only his/her native language, it would be very inconvenient for the user to understand the text contexts of an electronic document written in another language.

Presently in the information industry, there exists many various kinds of online translation utilities that can be used to translate the text contents of electronic documents of various formats, such as Microsoft Word documents (*.doc), EXCEL documents (*.xls), POWERPOINT documents (*.ppt), pure text documents (*.txt), Web page documents (*.htm, *html), to name just a few, from one language to another, such as from Traditional Chinese to Simplified Chinese, from English to Traditional Chinese, from Japanese to Traditional Chinese, and so on. Beside single document translation, users can also choose to translate a batch of selected electronic documents.

One drawback to the batch translation functionality of existing online translation utilities, however, is that it is quite tedious, laborious, and time-consuming for the user to operate; i.e., the user needs first to open a special control bar, then select desired document files from file management system and drop each selected document file into a queuing list, and whereupon the translation software will translate each document file in the queuing list one by one. Since the required manual operating steps are quite tedious, laborious, and time-consuming, it is quite user-unfriendly and inefficient for the user to operate.

### SUMMARY OF THE INVENTION

It is therefore an objective of this invention to provide a directory-oriented electronic document batch translation processing method and system which can provide a more user-friendly way for the user to operate the computer platform to perform a batch translation processing procedure on a group of document files under the same directory in file management system, so as to allow the batch translation to be more convenient and efficient to operate.

The directory-oriented electronic document batch translation processing method and system according to the invention is designed for use in conjunction with a computer platform, such as a desktop computer, a notebook computer, a tablet computer, a pocket computer, or the like, for providing a directory-oriented batch translation processing function that allows the computer platform to translate the text contents of a batch of electronic documents under a user-selected directory in the file management system into another language, such as from Traditional Chinese to Simplified Chinese, from English to Traditional Chinese, from Japanese to Traditional Chinese, and so on.

The directory-oriented electronic document batch translation processing method and system according to the invention is characterized by the capability of performing a batch translation processing procedure on all document files or one or more user-selected document file under a user-selected directory from the file management system so as to translate the text contents of these document files from a first specified language to a second specified language. This feature allows batch translation to be more convenient and efficient for the user to operate than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing he application architecture and modularized object-oriented component model of the directory-oriented electronic document batch translation processing system according to the invention;

FIG. 2A is a schematic diagram showing a first application example of the directory-oriented electronic document batch translation processing system of the invention; and

FIG. 2B is a schematic diagram showing a second application example of the directory-oriented electronic document batch translation processing system of the invention.

### DETAILED DESCRIPTION OF PREFERRED EMBODIMENTS

The directory-oriented electronic document batch translation processing method and system according to the invention is disclosed in full details by way of preferred embodiments in the following with reference to the accompanying drawings.

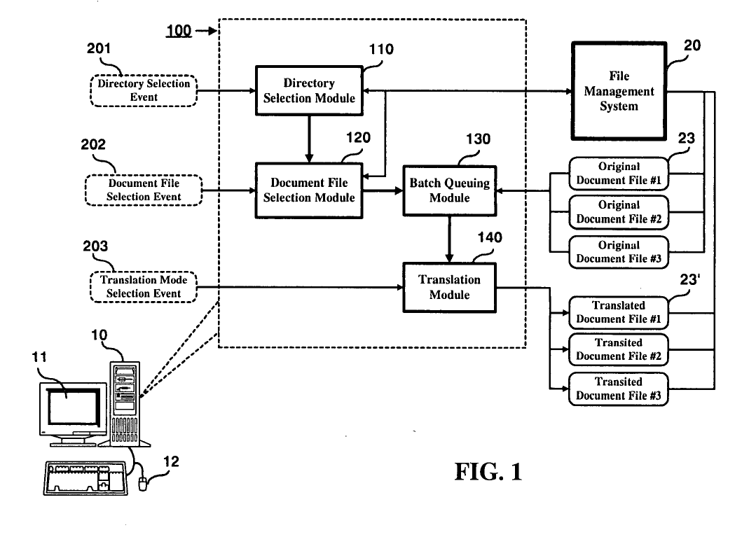

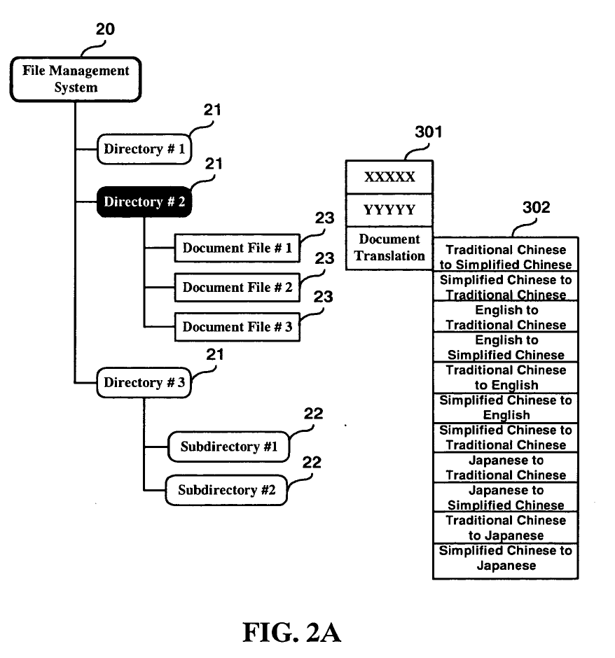

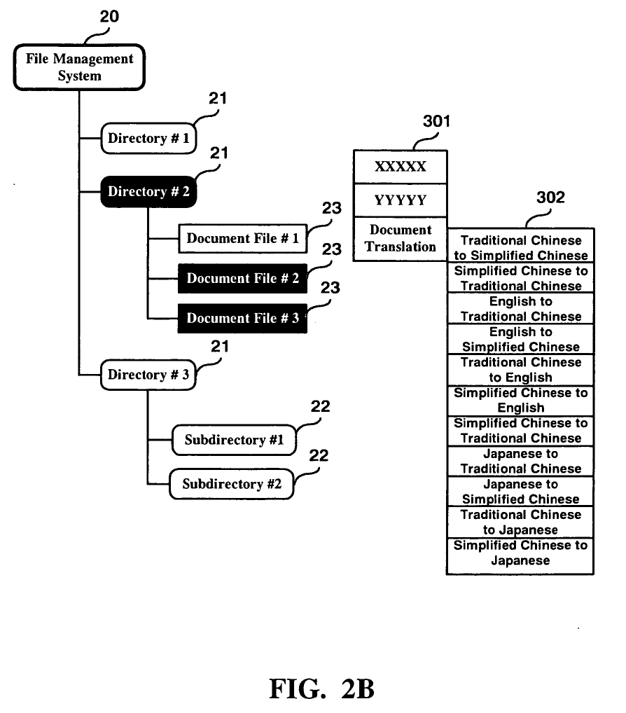

FIG. 1 is a schematic diagram showing the application architecture and object-oriented component model of the directory-oriented electronic document batch translation processing system according to the invention (as the part enclosed in the dotted box indicated by the reference numeral 100). As shown, the directory-oriented electronic document batch translation processing system of the invention 100 is designed for use with in conjunction with a computer platform 10, such as a desktop computer, a notebook computer, a tablet computer, a pocket computer, or the like, that utilizes a directory-based file management system 20 as shown in FIGS. 2A-2B for managing all the document files 23 stored in the computer platform 10. This file management system 20 utilizes a hierarchical structure of directories 21 and subdirectories 22 for the organization of document files 23 in the computer platform 10 (note that the hierarchical structure of the file management system 20 shown in FIGS. 2A-2B only shows three directories 21 and two subdirectories 22 for demonstrative purpose, and in practice, the number of directories and subdirectories is unlimited; and the term “directory” may be named differently in other operating systems or application programs, such as named “folder” in Microsoft Windows operating systems.

Functionally, the directory-oriented electronic document batch translation processing system of the invention 100 is capable of providing a directory-oriented batch translation processing function that allows the user to specify a directory 21 or subdirectory 22 (hereinafter called “target directory”) in the file management system 20 such that all the document files 23 or one or more user-selected document files 23 in the user-specified target directory will be processed in batch to translate the text contents of each selected document file 23 in the target directory from a first specified language to a second specified language, such as from Traditional Chinese to Simplified Chinese, from English to Traditional Chinese, from Japanese to Traditional Chinese, and so on.

As shown in FIG. 1, the modularized object-oriented component model of the directory-oriented electronic document batch translation processing system of the invention 100 comprises: (a) a directory selection module 110; (b) a document file selection module 120; (c) a batch queuing module 130; and (d) a translation module 140.

The directory selection module 110 is capable of responding to a user-operated directory selection event 201 by selecting a user-desired target directory (which can be either a directory 21 or a subdirectory 22) from the file management system 20. In practice, for example, the user can initiate the directory selection event 201 by using the left-button of the mouse 12 to select the desired directory 21 from the file management system 20 displayed on the screen 11 of the computer platform 10.

The document file selection module 120 is capable of being activated by a user-operated document file selection event 202 to select a batch of document files 23 under the currently-selected target directory 21 in the file management system 20 selected by the directory selection module 110. In practice, for example, the user can initiate the document file selection event 202 by using the left-button of the mouse 12 to select each desired document file 23 in the currently-selected directory 21. The document file selection module 120 has the ability to provide a whole-directory selection function, a single file selection function, and a multiple file selection function; wherein the whole-directory selection function is a default function that automatically selects all of the document files 23 under the user-selected target directory 21 if no user-operated file selection is initiated; the single file selection function allows the user to select one desired document file 23 in the currently-selected directory 21 by means of the mouse 12; and the multiple file selection function allows the user to select two or more desired document files 23 in the currently-selected directory 21 by means of the mouse 12.

The batch queuing module 130 is a capable of acquiring the filenames of all the document files 23 selected by the document file selection module 120 and putting these filenames in a queue, so that the selected document files 23 can wait in the queue for translation.

The translation module 140 is capable of providing one or more translation modes, such as [Traditional Chinese to Simplified Chinese], [Simplified Chinese to Traditional Chinese], [English to Traditional Chinese], [English to Simplified Chinese], [Traditional Chinese to English], [Simplified Chinese to English], [Simplified Chinese to Traditional Chinese], [Japanese to Traditional Chinese], [Japanese to Simplified Chinese], [Traditional Chinese to Japanese], and [Simplified Chinese to Japanese], to name just a few. If two or more translation modes are available, the translation module 140 is capable of responding to a user-operated translation mode selection event 203 to thereupon translate the queued batch of document files 23 in the batch queuing module 130 one by one in the user-specified translation mode from a first specified language to a second specified language. After the translation is completed, the translated text data are stored into new document files 23′ which can be either separate files aside from the original document files 23, or used to overwrite the original document files 23. In addition, the translation module 140 can further include a filtering function which is capable of filtering out each format-incompatible document files from the queued batch, so that the translation process is performed only on format-compatible document files.

Referring to FIG. 1 together with FIG. 2A, in a first application example, it is assumed that the user wants all of the document files 23 under a particular target directory 21 in the file management system 20 to be translated from English to Traditional Chinese. In this case, the user needs first to utilize the mouse 12 to select the desired directory 21 from the file management system 20 displayed on the screen 11 of the computer platform 10 to thereby initiate a directory selection event 201, causing the directory selection module 110 to respond by selecting and acquiring the name attribute of the user-selected directory 21. In FIG. 2A, the user-selected target directory 21 is shown in highlight. When the target directory 21 is selected, the file management system 20 will display all of the document files 23 stored under the target directory 21. After the target directory 21 is selected, the user can next activate the opening of a popup menu 301 as shown in FIG. 2A by, for example, clicking the right-button of the mouse 12. The popup menu 301 contains an option named [File Translation]. When [File Translation] is selected, it will further display a translation mode menu 302 showing all of the available translation modes, including, for example, [Traditional Chinese to Simplified Chinese], [Simplified Chinese to Traditional Chinese], [English to Traditional Chinese], [English to Simplified Chinese], [Traditional Chinese to English], [Simplified Chinese to English], [Simplified Chinese to Traditional Chinese], [Japanese to Traditional Chinese], [Japanese to Simplified Chinese], [Traditional Chinese to Japanese], and [Simplified Chinese to Japanese]. Since the user wants an English to Traditional Chinese translation mode, the user needs just to utilize the left-button of the mouse 12 to click on the [English to Traditional Chinese] option on the translation mode menu 302, which will activate the initiation of a translation mode selection event 203. Since in this case only the target directory 21 is selected and no document files 23 are selected, the document file selection module 120 will automatically select all of the document files 23 in the target directory 21 by default, and then activate the batch queuing module 130 to put the filenames of all the selected document files 23 in a queue, so that the selected document files 23 can wait in the queue for translation. Next, the translation module 140 is activated to translate the queued batch of document files 23 in the batch queuing module 130 one by one in the user-specified translation mode (i.e., English to Traditional Chinese), so as to translate the text contents of each of the queued document files 23 from English to Traditional Chinese.

Referring to FIG. 1 together with FIG. 2B, in a second application example, it is assumed that the user wants only two of the document files 23 under a particular target directory 21 in the file management system 20 to be translated from English to Traditional Chinese. In this case, the user needs first to utilize the mouse 12 to select the desired directory 21 from the file management system 20 displayed on the screen 11 to thereby initiate a directory selection event 201, causing the directory selection module 110 to respond by selecting and acquiring the name attribute of the user-selected directory 21. In FIG. 2B, the user-selected directory 21 is shown in highlight. When the target directory 21 is selected, the file management system 20 will display all of the document files 23 stored in the target directory 21, whereupon the user can utilize the left-button of the mouse 12 to click on each desired document file 23 (in this example, two document files 23 are selected, which are shown in highlight in FIG. 2B). After the desired two document files 23 are selected, the user can next activate the opening of a popup menu 301 by clicking the right-button of the mouse 12. The popup menu 301 contains an option named [File Translation]. When [File Translation] is selected, it will further display a translation mode menu 302 which shows all of the available translation modes. Since the user wants an English-to-Traditional-Chinese translation mode, the user needs just to utilize the left-button of the mouse 12 to click on the [English to Traditional Chinese] option on the translation mode menu 302, which will activate the initiation of a translation mode selection event 203. Since the user has selected two document files 23 from the target directory 21, the document file selection module 120 will activate the batch queuing module 130 to put the filenames of these two user-selected document files 23 in a queue, so that these two user-selected document files 23 can wait in the queue for translation. Next, the translation module 140 is activated to translate the two queued document files 23 in the batch queuing module 130 one by one in the user-specified translation mode (i.e., English to Traditional Chinese), so as to translate the text contents of each of the two document files 23 from English to Traditional Chinese.

In conclusion, the invention provides a directory-oriented electronic document batch translation processing method and system use with a computer platform, which is characterized by the capability of performing a batch translation processing procedure on all document files or one or more user-selected document file under a user-selected directory from the file management system so as to translate the text contents of these document files from a first specified language to a second specified language. This feature allows batch translation to be more convenient and efficient for the user to operate than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A directory-oriented electronic document batch translation processing method for use on a computer platform having a file management system for managing documents under a hierarchical structure of directories for the purpose of providing a directory-oriented batch translation processing function for translating a batch of user-desired document files from a first specified language to a second specified language;
the directory-oriented electronic document batch translation processing method comprising:
responding to a user-operated directory selection event by selecting a user-desired target directory from the file management system;
responding to a user-operated document file selection event by selecting a batch of document files from the currently-selected target directory in the file management system;
queuing the batch of user-desired document files in a queue; and
responding to a user-operated translation mode selection event by translating the queued batch of document files in the queue one by one in user-specified translation mode so as to translate the text contents of each document file from a first specified language to a second specified language.

2. The directory-oriented electronic document batch translation processing method of claim 1, wherein the computer platform is a desktop computer.

3. The directory-oriented electronic document batch translation processing method of claim 1, wherein the computer platform is a notebook computer.

4. The directory-oriented electronic document batch translation processing method of claim 1, wherein the computer platform is a tablet computer.

5. The directory-oriented electronic document batch translation processing method of claim 1, wherein the computer platform is a pocket computer.

6. The directory-oriented electronic document batch translation processing method of claim 1, wherein the document file selection event includes a whole-directory selection function, a single file selection function, and a multiple file selection function.

7. The directory-oriented electronic document batch translation processing method of claim 1, further comprising:
performing a filtering procedure for filtering out each format-incompatible document file from the queued batch of document files so as to perform the translation only on format-compatible document files.

8. A directory-oriented electronic document batch translation processing system for use with a computer platform having a file management system for managing documents under a hierarchical structure of directories for the purpose of providing a directory-oriented batch translation processing function for translating a batch of user-desired document files from a first specified language to a second specified language;
the directory-oriented electronic document batch translation processing system comprising:
a directory selection module, which is capable of responding to a user-operated directory selection event by selecting a user-desired target directory from the file management system;
a document file selection module, which is capable of responding to a user-operated document file selection event by selecting a batch of document files from the currently-selected target directory in the file management system selected by the directory selection module;
a batch queuing module, which is used to queue the batch of user-desired document files selected by the document file selection module; and
a translation module, which is capable of responding to a user-operated translation mode selection event by translating the queued batch of document files in the batch queuing module one by one in user-specified translation mode so as to translate the text contents of each document file from a first specified language to a second specified language.

9. The directory-oriented electronic document batch translation processing system of claim 1, wherein the computer platform is a desktop computer.

10. The directory-oriented electronic document batch translation processing system of claim 1, wherein the computer platform is a notebook computer.

11. The directory-oriented electronic document batch translation processing system of claim 1, wherein the computer platform is a tablet computer.

12. The directory-oriented electronic document batch translation processing system of claim 1, wherein the computer platform is a pocket computer.

13. The directory-oriented electronic document batch translation processing system of claim 1, wherein the document file selection module optionally provides a whole-directory selection function, a single file selection function, and a multiple file selection function.

14. The directory-oriented electronic document batch translation processing system of claim 1, wherein the translation module includes a filtering function which is capable of filtering out each format-incompatible document file from the queued batch of document files so as to perform the translation only on format-compatible document files.
